(19) United States
(12) Patent Application Publication
(10) Pub. No.: US 2020/0263834 A1
(43) Pub. Date: Aug. 20, 2020

(54) DEVICE, FACILITY AND METHOD FOR SUPPLYING GAS

(71) Applicant: L'Air Liquide, Société Anonyme pour l'Etude et l'Exploitation des Procédés Georges Claude, Paris (FR)

(72) Inventors: Fouad AMMOURI, Massy (FR); Stephane BONNETIER, Utrecht (NL)

(21) Appl. No.: 16/794,324

(22) Filed: Feb. 19, 2020

(30) Foreign Application Priority Data
Feb. 19, 2019 (FR) 1901644

(51) Int. Cl. F17C 13/04; F17C 13/02; F17C 5/00

(52) U.S. Cl. CPC F17C 13/045; F17C 13/025; F17C 13/026; F17C 5/002; F17C 2205/0388; F17C 2250/0439; F17C 2250/0636; F17C 2260/038; F17C 2250/043

(57) ABSTRACT

Gas supplying device including a changeover unit, the changeover unit including two inlets connected to two distinct pressurized gas sources, and one outlet connected to a user member, the changeover unit including an automatic and/or manual switchover mechanism making it possible to switch the supply of gas to the user member to one source or to the other source so as to ensure continuity of supply, the device including a pressure sensor measuring the gas pressure at the outlet and/or at least one inlet of the changeover unit, wherein the device includes an ambient temperature sensor and an electronic data processing and storage member, the electronic data processing and storage member receiving the measurement from the ambient temperature sensor and the measurement from the pressure sensor and being configured to calculate, the corrected variation in gas pressure which is not caused by the variation in ambient temperature.

### CROSS REFERENCE TO RELATED APPLICATIONS

This application claims the benefit of priority under 35 U.S.C. § 119 (a) and (b) to French Patent Application No. 1901644, filed Feb. 19, 2019, the entire contents of which are incorporated herein by reference.

### BACKGROUND

The invention relates to a device, to an installation and to a method for supplying gas.

The invention relates more particularly to a gas supplying device comprising a changeover unit, the changeover unit comprising two inlets intended to be connected respectively to two distinct pressurized gas sources, and one outlet intended to be connected to a user member, the changeover unit comprising an automatic and/or manual switchover mechanism making it possible to switch the supply of gas to the user member to one source or to the other source so as to ensure continuity of supply, the device comprising a pressure sensor measuring the gas pressure at the outlet and/or at least one inlet of the changeover unit.

A changeover unit for racks of gas cylinders is made up of a manual and/or automatic switching system. This system, which is well known, makes it possible to change the supply of gas to a unit from a first cylinder or a first cylinder rack to a second cylinder or a second cylinder rack when the pressure level in the first rack being used drops below a certain safety threshold. The role of the changeover unit is to ensure continuous supply of gas when changing rack or cylinder(s).

The changeover unit is often fitted with a pressure reducer to make it possible to reduce the pressure of the gas in the source cylinders to the pressure level needed for the end-use.

A pressure sensor supplied by a wire or else a pressure gauge is often installed upstream of the pressure reducer (downstream of the outlet of the changeover unit) to monitor the pressure remaining in the gas source and thus determine whether it is necessary to switch from one gas source to the other.

This measured pressure is subject to the variations in ambient temperature. Specifically, the more the ambient temperature increases, the more the pressure in the unused source cylinders has a tendency to increase (and vice versa if the temperature drops). The impact of the variations in ambient temperature introduces non-insignificant errors into the estimate of the mass of gas remaining in the gas source and also into the pressure variations.

Leaks in a pipe supplied by a volume of gas under pressure are often detected using one or more external detectors installed along the pipe. This system therefore requires a gas detector to be installed at regular intervals. For a gas pipe several tens of metres long, that represents a significant cost and painstaking regular monitoring to calibrate the detectors in order to ensure that they remain reliable over time.

### SUMMARY

One aim of the present invention is to overcome all or some of the abovementioned disadvantages of the prior art.

To this end, the device according to the invention, in other respects in accordance with the generic definition given thereof in the above preamble, is essentially characterized in that the device comprises an ambient temperature sensor and an electronic data processing and storage member, the electronic data processing and storage member receiving the measurement from the ambient temperature sensor and the measurement from the pressure sensor and being configured to calculate, from these ambient temperature and pressure measurements, the corrected variation in gas pressure which is not caused by the variation in ambient temperature.

Moreover, embodiments of the invention may comprise one or more of the following features:
the device comprises a sensor detecting the consumption of gas delivered by the gas supply device, the electronic data processing and storage member receiving the signal from this gas consumption detection sensor and being configured to detect a leak and in response to generate an alert signal when the corrected calculated variation in gas pressure exceeds the actual variation in pressure corresponding to the signal from the sensor detecting the consumption of gas delivered,
the electronic data processing and storage member is configured to detect a leak and in response to generate an alert signal when the consumption detection sensor does not detect any consumption of gas delivered by the device even though the corrected calculated variation in gas pressure corresponds to a decrease in pressure,
the device comprises a pressure reducer positioned at the outlet of the changeover unit and configured to lower the pressure delivered to a user member to a determined value.

The invention also relates to a facility for supplying gas to a user member comprising a gas supply device according to any one of the features hereinabove or hereinbelow and two pressurized gas sources connected respectively to the two inlets of the changeover unit.

The invention also relates to a method for supplying gas to a user member by means of a circuit including a changeover unit connected to two distinct pressurized gas sources, the changeover unit comprising an automatic and/or manual switchover mechanism making it possible to switch the supply of gas to the user member to one source or to the other source so as to ensure continuity of supply, the method comprising a step of measuring the pressure of the gas in the circuit, notably between the changeover unit and the user member, a step of measuring the ambient temperature, a step of calculating the corrected pressure of the gas in the circuit from measured pressure and ambient temperature values, in order to determine the variations in pressure caused solely by a transfer of gas from a source towards the user member.

According to other possible distinctive features:
the method comprises a step of detecting a supply of gas to a user member via the circuit and, when the calculated corrected pressure decreases and no supply of gas to a user member is detected, a step of generating an alert signal,
the temperature of the gas in the circuit and notably in the sources is approximated using the moving average of the ambient temperature measured over a duration equal to three times the characteristic total time taken for an exchange of heat between the ambient surroundings and the gas in the source,
the corrected variation in gas pressure is calculated by calculating the pressure P (in Pa) from the real-gas equation [Math 1] PV=n.R.Z.T in which V is the volume of the gas (in m³), n is the number of moles of gas, R is the perfect gas constant (in J.K⁻¹.mol⁻¹), Z is the compressibility factor for the gas in question (dimensionless but dependent on the nature of the gas, on the temperature and on the pressure of the gas), T is the temperature of the gas (in K), and the temperature T of the gas is approximated as a moving average of the ambient temperature measured over a determined duration of between one hour and five hours, and notably of three hours,
the corrected pressure (Pc) of the gas in the circuit is calculated in the form of a polynomial function of the temperature T of the gas (in degrees K), the coefficients of which are polynomials of measured pressure (P in bara),
the corrected pressure (Pc) of the gas in the circuit is calculated in the form of a 2nd-order polynomial function of the temperature T of the gas (in degrees K), the coefficients of which are 3rd-order polynomials of measured pressure (P in bara) [Math 8]; Pc=[A.P³+B.P²+C.P+D].T²+[E.P³+F.P²+G.P+H]. T+[I.P³+K.P+L]

in which the coefficients A, B, C, D, E, F, G, H, I, J, K and L are real coefficients obtained by polynomial smoothing of the function involving the gas compressibility coefficient.

The invention can also relate to any alternative device or method comprising any combination of the features above or below within the scope of the claims.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 shows a schematic and partial view illustrating one example of the structure and operation of the invention.

### DETAILED DESCRIPTION OF THE PREFERRED EMBODIMENTS

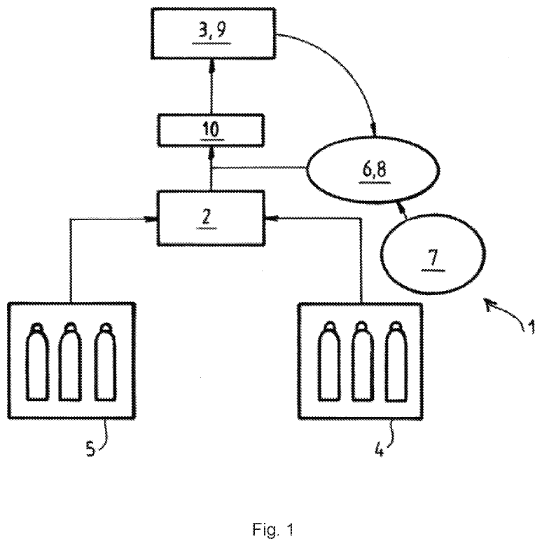

The gas supply facility illustrated in FIG. 1 comprises two racks 4, 5 of pressurized gas cylinders respectively connected to two inlets of a changeover unit 2. As illustrated, at the outlet of the changeover unit 2, the circuit may comprise a pressure reducer 10 for regulating the pressure supplied to the user 3 to a determined value. The facility comprises a pressure sensor 6 measuring the pressure in the circuit prior to pressure reduction.

The facility 1 further comprises an ambient temperature sensor 7, measuring for example the temperature around the rack of sources 4, 5.

The facility comprises (either locally or sited remotely) an electronic data processing and storage member 8. This electronic member 8 comprises, for example, a microprocessor, a computer, an electronic board and/or any other appropriate device. This electronic data processing and storage member 8 is configured (connected) in such a way as to receive the measurement from the ambient temperature sensor 7 and the measurement from the pressure sensor 6. In addition, this electronic member 8 is configured (notably programmed or operated) so as to calculate, from these measurements, the corrected variation in gas pressure which is not caused by the variation in ambient temperature.

For example, this electronic member 8 is connected to the pressure measurement, to the ambient temperature measurement, and receives information or a signal indicative of whether or not the facility is being used (whether or not it is supplying gas).

As illustrated and nonlimitingly, the electronic member 8 may be situated physically in the region of the pressure sensor 6. The signals from the sensors may be transmitted by wire or wirelessly (Bluetooth or Internet-of-Things signals for example).

The device thus makes it possible to detect leaks of gas in the circuit (notably in a pipe downstream of the changeover unit 2) on the basis of the profile of pressure measurement measured by the pressure sensor 6 and on the basis of the ambient temperature measured by the sensor 7.

Specifically, the measured pressure value is corrected with respect to the variation in ambient temperature. That makes it possible for example to analyse the gradient of (variation in) corrected pressure in order to detect whether or not there is a gas leak.

Thus, the pressure measurement (before pressure reduction in the event that there is pressure reduction), the ambient temperature measurement and a signal indicative of whether the gas is being used/not used makes it possible to detect whether or not there is a gas leak in the circuit (between the pressurized gas source 4, 5 and the final point at which the gas is used downstream of the changeover unit 2).

Specifically, according to the real gas law (or possibly according to the perfect gas law, but with lower precision), there is a relationship

P V=n R Z T [Math 1]

where Vis the volume of the gas given in m3, P is the pressure of the gas in Pa, T is the temperature of the gas in K, n is the number of moles contained in the volume, and Z is the compressibility of the gas (a factor dependent on the nature of the gas, on the temperature and on the pressure of the gas).

This relationship can be expressed in the form of a mass of gas m contained in the volume V as a function of the other parameters already mentioned

$$m = n M = \frac{PVM}{RZT} \qquad [ Math 2 ]$$

M being the molar mass of the gas. For a given gas and volume, the mass of gas contained in that volume is constant if the following ratio remains constant

$$\frac{P}{ZT} = f ( T , P ) \qquad [ Math 3 ]$$

This ratio is dependent on the pressure and on the mean temperature of the gas in the volume. Now, it is very difficult to measure the temperature inside one or more gas cylinders. According to the invention, the mean temperature of the gas in the source or the circuit is deduced (approximated) from the measurement of ambient temperature around this source. In order to do that, the variations in the temperature of the gas inside the cylinders are deduced from the variations in ambient temperature.

This is because the variation in ambient temperature around the sources 4, 5 influences the temperature of the gas in the sources through the heat flux that passes through the walls of the cylinders. The heat flux, which is by nature convective and radiative on the external wall of the cylinders becomes a conductive flux through the wall of the cylinders and then becomes a heat flux by convection between the internal wall of the cylinder and the gas inside.

In order to estimate the time needed for the internal gas temperature to vary as a result of the variations in ambient temperature, it is often common practice to introduce characteristic times relating to each of the modes of heat transfer across the wall of the cylinder.

The characteristic time for heat transfer around the external wall of he cylinder can be calculated using the following formula

$${τ}_{e} = \frac{{m}_{w} {Cp}_{w}}{{k}_{e} {S}_{e}} \qquad [ Math 4 ]$$

Where m_{w} is the mass (in kg) of the wall of a cylinder and Cp_{w} is the specific heat capacity of the wall of the cylinder (in W/(m².K)), kₑ is the total (convective and radiative) external exchange coefficient (in W/(m².K)) around the wall of the cylinder and Sₑ is the external surface area of the wall of the cylinder (in m²).

For example, for a metal cylinder of type B50 made of steel, weighing 74 kg with a total external exchange coefficient of the order of 10 W/(m².K), with an internal volume of 50 litres and an external exchange surface area of 1.08 m², this characteristic external heat exchange time therefore equates to (74×460)/(10×1.08)=3152 seconds.

The characteristic time for convection on the internal wall of the cylinder can be calculated using the following formula

$${τ}_{cvi} = \frac{{m}_{g} C {p}_{g}}{{k}_{cvi} {S}_{i}} \qquad [ Math 5 ]$$

Where k_{cvi} is the coefficient for convective exchange between the gas in the cylinder and the internal wall of this cylinder, Si is the internal surface area of the wall of the cylinder in contact with the gas (in m^{2), m}_{g} is the mass of gas contained in the cylinder (in kg) and c_{pg} is the specific heat capacity of that gas.

For example, for a metal cylinder of type B50 containing for example carbon monoxide (CO) at 100 barg of which the mass in the cylinder at 15° C. is 5.94 kg, the specific heat capacity is 1234 J/(kg.K), the internal convective exchange coefficient is of the order of 50 W/(m².K), the internal exchange surface area is 1 m², the characteristic internal convection time equates to (5.94×1234)/(50×1)=146.6 seconds.

The characteristic time for conduction through the thickness of the wall of the cylinder can be expressed in the form

$${τ}_{cd} = \frac{{e}_{w}^{2}}{{a}_{w}} \qquad [ Math 6 ]$$

where e_{w} is the wall thickness of the cylinder and aw is the thermal diffusivity of this wall. For a cylinder of type B50 made of stainless steel of which the mean thickness is 9 mm and of which the thermal diffusivity of the wall is 4×35×10⁻⁶ m²/s, the value obtained for this characteristic time is 81×10⁻⁶/4.35×10⁻⁶=18.6 seconds.

The total characteristic time for transfer of heat from the ambient surroundings around the cylinder to the gas inside the cylinder can be represented by the sum of the 3 characteristic times mentioned above, namely 3152+18.6+146.6=3317 seconds=55.3 minutes, namely approximately one hour.

Therefore, the order of magnitude of the total characteristic time is approximately 1 hour, and is markedly dominated by the characteristic external heat exchange time which represents almost all (95%) of the total time. In other words, the variation in the temperature of the gas inside the cylinder reaches that of the ambient temperature after approximately three times the total characteristic time.

It has been found that the moving average of the ambient temperature over a duration of 3 hours (three times the total characteristic time) provides a good estimate of the internal temperature of the gas inside the cylinder in instances in which there is no consumption of gas.

Thus, the temperature T of the gas can be approximated by the moving average of the ambient temperature over a duration of between one hour and five hours and notably three hours.

In conclusion, the mean temperature of the gas in the cylinder without consumption, namely without withdrawal, can be approximated by the moving average over a duration equal to three times the total characteristic time for the exchange of heat between the ambient surroundings and the gas in the cylinder.

The corrected pressure Pc (which is proportional to the mass of gas remaining in the cylinder) takes account of the variations in gas temperature and of the compressibility factor Z in the form of

P_{c}(T, P)=f(T, P)*Z₀ (T_{0,} P₀)*T₀ [Math 7]

Where f(T, P) is a function dependent on the nature of the gas, on the pressure and on the temperature of the gas in the cylinder. This function can be tabulated or else fitted using a polynomial in T and P.

Z₀(T₀, P₀) is the gas compressibility factor at T₀ and P₀ (these respectively being the initial temperature and initial pressure) of the cylinder after filling (for example 220 barg and 15° C.=288.15K).

The corrected pressure Pc can be put in the form of a 2nd-order polynomial function in T (temperature of the gas in the cylinder), where the coefficient are 3rd-order polynomials in P (pressure measured in the cylinder or cylinders of the rack before pressure reduction) where P is in bara and T is in K (the temperature can be expressed in degrees K or in degrees C., but in that case the value of the coefficients is modified accordingly),

P_{c} (T,P)=[A.P³+B.P+C.P+D]. T³+[E.P³+F.P²+G.P+H]. T+[I.P³+J.P²+K.P+L] [Math 8]

The coefficients A to L can be noted down as the values of a matrix A(3, 4), which, for carbon monoxide (CO) with P₀=221 bara and T₀=15° C.=288,15K, can be defined in the table below:

TABLE 1

| −5.51605E−10 | 1.51951E−07 | 1.66395E−05 | −4.36997E−05 |
|---|---|---|---|
| 3.70776E−07 | −0.0001018 | −0.013670931 | 0.028489057 |
| −6.31947E−05 | 0.016902099 | 3.622898655 | −4.695505679 |

These coefficients are dependent on the nature of the gas. Specifically, the formula for the corrected pressure Pc involves the gas compressibility coefficient. This coefficient is dependent on the nature of the gas, on the temperature of the gas, and on the pressure thereof. This compressibility coefficient Z can be tabulated for each gas as a function of the temperature and of the pressure of the gas. This compressibility coefficient Z can be extracted on the basis for example of the data provided on the NIST (National Institute of Standards and Technology) website (https://webbook.nist.gov/chemistry/). Once the compressibility coefficient for the gas in question is known, the corrected pressure for various gas pressures and gas temperatures is then calculated. Next, curve-fitting is performed using one, or if need be several, polynomial fit functions that allow the corrected pressure to be reproduced across the entire domain of variation of the gas temperature and pressure. The coefficients A, B, C, D, E, F, G, H, I, J, K and L for the gas in question are thus obtained from the polynomial fitting.

Thus, with the knowledge of the pressure measurement from the sensor 6 and the gas temperature T deduced from the ambient temperature measured by the sensor 7, the device can calculate the corrected pressure Pc from the previous formula.

If the electronic member 8 receives a signal indicative of non-use of the gas in the network after the changeover unit (no withdrawal, no supply of gas to the user 3), and if at the same time the corrected pressure Pc calculated using the previous formula is decreasing with time (for example if Pc(t)−Pc(t+delta t) is above a threshold), that indicates that there is a leak in the circuit. An alert signal (visual and/or audible) may be generated and any other action (shutdown, closure of valves, etc.) may be triggered. The signal indicative of non-use of the gas on the network may be obtained for example by a valve-closed signal at the end-use of the gas or else by a zero-flow signal at the flowmeter very close to the end-use of the gas.

This threshold, in bar, may be equal to at least twice the precision of the pressure sensor used (for example a threshold of 5 bar for a sensor having a maximum of 250 bar with a precision of 1%). The value delta t is preferably of the order of several hours, notably three hours as discussed above.

That being the case, a signal may be displayed at the pressure sensor and/or a message may be transmitted over a distance using, for example, the Internet of Things, or else a GSM network or any other telecommunications network (Bluetooth, etc.) in order to alert to the presence of a gas leak.

What is claimed is:

1. A gas supplying device comprising a changeover unit, the changeover unit comprising two inlets intended to be connected respectively to two distinct pressurized gas sources, and one outlet configured to be connected to a user member, the changeover unit comprising an automatic and/or manual switchover mechanism making it possible to switch the supply of gas to the user member to one source or to the other source so as to ensure continuity of supply when using the device, the device comprising a pressure sensor measuring the gas pressure at the outlet and/or at least one inlet of the changeover unit, the device comprising an ambient temperature sensor and an electronic data processing and storage member, the electronic data processing and storage member receiving the measurement from the ambient temperature sensor and the measurement from the pressure sensor and being configured to calculate, from these ambient temperature and pressure measurements, the corrected variation in gas pressure which is not caused by the variation in ambient temperature, and in that it comprises a sensor detecting the consumption of gas delivered by the gas supply device, the electronic data processing and storage member receiving the signal from this gas consumption detection sensor and being configured to detect a leak and in response to generate an alert signal when the corrected calculated variation in gas pressure exceeds the actual variation in pressure corresponding to the signal from the sensor detecting the consumption of gas delivered.

2. The device according to claim 1, wherein the electronic data processing and storage member is configured to detect a leak and in response to generate an alert signal when the consumption detection sensor does not detect any consumption of gas delivered by the device even though the corrected calculated variation in gas pressure corresponds to a decrease in pressure,

3. The device according to claim 1, further comprising a pressure reducer positioned at the outlet of the changeover unit and configured to lower the pressure delivered to a user member to a determined value.

4. A facility for supplying gas to a user member comprising a gas supply device according to claim 1 and two pressurized gas sources connected respectively to the two inlets of the changeover unit.

5. A method for supplying gas to a user member by means of a circuit including a changeover unit connected to two distinct pressurized gas sources, the changeover unit comprising an automatic and/or manual switchover mechanism configured to enable the switch the supply of gas to the user member to one source or to the other source so as to ensure continuity of supply when using the device, the method comprising a step of measuring the pressure of the gas in the circuit, a step of measuring the ambient temperature, a step of calculating the corrected pressure of the gas in the circuit from measured pressure and ambient temperature values, in order to determine the variations in pressure caused solely by a transfer of gas from a source towards the user member, the method comprising a step of detecting a supply of gas to a user member via the circuit and, when the calculated corrected pressure decreases and no supply of gas to a user member is detected, a step of generating an alert signal.

6. The method according to claim 5, wherein the temperature of the gas in the circuit and is approximated using the moving average of the ambient temperature measured over a duration equal to three times the characteristic total time taken for an exchange of heat between the ambient surroundings and the gas in the source.

7. The method according to claim 5, wherein the corrected variation in gas pressure is calculated by calculating the pressure P from the real-gas equation PV=n.R.Z.T in which V is the volume of the gas, n is the number of moles of gas, R is the perfect gas constant, Z is the compressibility factor for the gas, T is the temperature of the gas, and wherein the temperature T of the gas is approximated as a moving average of the ambient temperature measured over a determined duration of between one hour and five hours.

8. The method according to claim 5, wherein the corrected pressure of the gas in the circuit is calculated in the form of a polynomial function of the temperature T of the gas, the coefficients of which are polynomials of measured pressure.

9. The method according to claim 5, wherein the corrected pressure of the gas in the circuit is calculated in the form of a 2nd-order polynomial function of the temperature T of the gas, the coefficients of which are 3rd-order polynomials of measured pressure:
Pc=[A, P³+B.P²+C.P+D].T²+[E.P³+F.P²+G.P+H].T+[I.P³+J.P²+K.P+L],
in which the coefficients A, B, C, D, E, F, G, H, I, J, K and L are real coefficients obtained by polynomial smoothing of the function involving the gas compressibility coefficient.
